(19) United States
(12) Patent Application Publication
(10) Pub. No.: US 2002/0063241 A1
(43) Pub. Date: May 30, 2002

(54) Corrosion inhibitor-drag reducer combinations

(76) Inventors: Bernardus Antonius Maria Oude Alink, Sugar Land, TX (US); Vladimir Jovancicevic, Richmond, TX (US)

Correspondence Address: PAUL S MADAN, MADAN, MOSSMAN & SRIRAM, PC, 2603 AUGUSTA, SUITE 700, HOUSTON, TX, 77057-1130, US

(21) Appl. No.: 09/952,873

(22) Filed: Sep. 11, 2001

Related U.S. Application Data
(60) Provisional application No. 60/240,680, filed on Oct. 16, 2000.

(51) Int. Cl. C09K 3/00; C23F 11/00

(52) U.S. Cl. 252/390; 252/391; 252/392; 252/394

(57) ABSTRACT

Drag reducers having the formula:

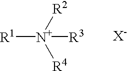

where R¹ is a straight or branched saturated alkyl having at least 12 carbon atoms;

R², R³ and R⁴ are independently lower alkyl of 1 to 4 carbon atoms, aryl, alkylaryl, or alkoxide where the alkoxide units constitute from 1 to 16 alkoxy moieties where the alkoxy moieties are independently from 2 to 4 carbon atoms, or any two of R², R³ and R⁴ are joined together to form cycloalkyl of 5 to 6 carbon atoms, or all three of R², R³ and R⁴ together with the N form a pyridinium ring, where R², R³ and R⁴ may be independently substituted with O or S; and

X⁻ is selected from the group of anions consisting of salicylate, thiosalicylate, sulfonate, and hydroxynaphthenate,

have been found to simultaneously function as corrosion inhibitors. Cetyltrimethylammonium salicylate (CTAS) and Cetylpyridinium salicylate (CPS) are particularly preferred drag reducers.

### FIELD OF THE INVENTION

The present invention relates to methods and compositions for inhibiting corrosion, and more particularly relates, in one embodiment, to methods and compositions for simultaneously inhibiting corrosion and reducing drag.

### BACKGROUND OF THE INVENTION

It is well known that steel tubulars and equipment used in the production of oil and gas are exposed to corrosive environments. Such environments generally consist of acid gases (CO₂ and H₂S) and brines of various salinities. Under such conditions the steel will corrode, possibly leading to equipment failures, injuries, environmental damage and economic loss. Further in some cases, drilling fluids have acid intentionally added thereto in order to acidize the formations to enhance hydrocarbon recovering. This added acid also causes corrosion problems.

While the rate at which corrosion will occur depends on a number of factors such as metallurgy, chemical nature of the corrosive agent, salinity, pH, temperature, etc., some sort of corrosion almost inevitably occurs. One way to mitigate this problem consists of using corrosion inhibitors in the hydrocarbon production system.

It is known that the corrosion of iron and steel alloys in contact with oil-in-brine emulsions can be inhibited by treating the emulsions with a water soluble polymer, specifically water soluble anionic, non-ionic and cationic polymers and nitrogen-containing corrosion inhibitors.

It would be advantageous if a new corrosion inhibitor were discovered that would be an improvement over the presently known systems. It is always desirable to produce greater corrosion inhibiting ability using less corrosion inhibiting material.

In another area, drag reduction is a term used to characterize the reduction in friction in turbulent flow through pipes resulting in an increase in fluid flow and/or decrease in turbulent pressure loss. Drag reduction in turbulent flow is an important phenomenon both for practical applications in fluid transport and for basic studies in fluid mechanics,

The main oilfield applications of chemicals capable of affecting drag reduction are in crude oil transportation and water reinfection lines.

Drag reducing agents (DRAs) used in crude oils are usually characterized as high molecular weight oil soluble polymers, while hydrolyzed polyacrylamide and polyacrylate have been used as DRAs in aqueous systems.

An important and fast-growing area of oilfield production, namely multiphase flow systems, is normally not treated with DRAs. Multiphase flow refers to flowing a hydrocarbon phase and a water phase together. Multiphase flow may even include a gas phase with water and/or hydrocarbon liquid phase(s).

### SUMMARY OF THE INVENTION

Accordingly, it is an object of the present invention to provide a corrosion inhibitor composition that is effective in inhibiting the corrosion of steel and iron surfaces in oil field tubing and other equipment.

It is another object of the present invention to provide a corrosion inhibitor that has additional benefits, such as drag reduction and/or a reduction in pumping power requirements.

In carrying out these and other objects of the invention, there is provided, in one form, a corrosion inhibited fluid that includes a fluid containing or having water therein and a composition in an effective amount to inhibit corrosion having the formula:

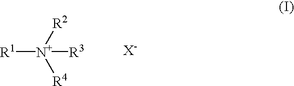

where R¹ is a straight or branched saturated alkyl having at least 12 carbon atoms;

R², R³ and R⁴ are independently lower alkyl of 1 to 4 carbon atoms, aryl, alkylaryl, or alkoxide where the alkoxide units constitute from 1 to 16 alkoxy moieties and the alkoxy moieties are independently from 2 to 4 carbon atoms. Any two of R², R³ and R⁴ may be joined together to form cycloalkyl of 5 to 6 carbon atoms, or all three of R², R³ and R⁴ together with the N form a pyridinium ring, where R², R³ and R⁴ may be independently substituted with O or S; and

X⁻ is selected from the group of anions consisting of salicylate, thiosalicylate, sulfonate, and hydroxynaphthenate.

### BRIEF DESCRIPTION OF THE DRAWINGS

FIG. 1 is a chart of the results of a vortex test of cetyltrimethylammonium salicylate in DI water;

FIG. 2 is a chart of the results of a vortex test of cetylpyridinium salicylate in DI water;

FIG. 3 is a graph of torque measurements for cetyltrimethylammonium chloride (CTACl), cetyltrimethylammonium salicylate (CTAS), cetylpyridinium chloride (CPCl), and cetylpyridinium salicylate (CPS) in DI water at 0.2 mMoles/l;

FIG. 4 is a chart of the results of surface tension measurements for CTACl and CTAS;

FIG. 5 is a chart of the results of surface tension measurements for CPCl and CPS;

FIG. 6 is a chart of iron counts as a function of time, for a test concentration of 0.2 mMoles/l of inhibitor in tap water; and

FIG. 7 is a graph of weight loss in mpy as a function of time, for a test concentration of 0.2 mMoles/l of inhibitor in tap water.

### DETAILED DESCRIPTION OF THE INVENTION

It has been discovered that products that simultaneously exhibit corrosion inhibiting and drag reducing properties can be developed. Development of DRAs for multiphase flow applications may offer significant reductions in turbulence and/or modification in the flow regime, in which case corrosion inhibition could be improved. A goal was to develop a molecule that simultaneously showed drag reduction and corrosion inhibition. It will be appreciated that as defined herein corrosion inhibition is any reduction, abatement, lowering, decrease, prevention, hindrance, or other suppression of the corrosion rate that would normally occur in the absence of the inventive composition. Successful practice of the invention does not depend upon the complete cessation of corrosion.

As will be shown, drag reduction by surfactant-type molecules is affected by the chemical structure of the counterion. One theory is that by a judicious choice of the counter ion, the shape of the micelles can be altered, but the invention should not be limited by any particular theory.

It has been discovered that molecules of the following formula exhibit both drag reducing and corrosion inhibiting properties simultaneously:

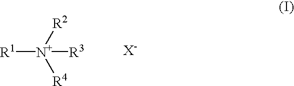

where R¹ is a straight or branched saturated alkyl having at least 12 carbon atoms;

R², R³ and R⁴ are independently lower alkyl of 1 to 4 carbon atoms, aryl, alkylaryl (where the alkyl of the alkylaryl group is C1 to C4), or alkoxide where the alkoxide units constitute from 1 to 16 alkoxy moieties and the alkoxy moieties are independently from 2 to 4 carbon atoms (ethoxy, propoxy, or butoxy), or any two of R², R³ and R⁴ may be joined together to form cycloalkyl of 5 to 6 carbon atoms, or all three of R², R³ and R⁴ together with the N form a pyridinium ring, where R², R³ and R⁴ may be independently substituted with O or S; and

X⁻ is selected from the group of anions consisting of salicylate, thiosalicylate, sulfonate, and hydroxynaphthenate, or derivatives thereof, although any anion capable of producing a product with drag reducing properties may be used.

In a preferred, non-limiting embodiment of the invention, R², R³ and R⁴ are independently lower alkyl of 1 to 4 carbon atoms, or all three of R², R³ and R⁴ together with the N form a pyridinium ring; and X⁻ is salicylate. Salicylate anion has the structure:

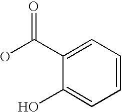

It will be appreciated that the salicylate, thiosalicylate, sulfonate, and hydroxynaphthenate possibilities for the X⁻ anion are not limited to only those exact structures or moieties, but include derivatives and substituents thereof. For example, the salicylate, thiosalicylate, sulfonate, and hydroxynaphthenate may be substituted with alkyl, alkoxy, halide and other groups and still be within the scope of the invention. In one non-limiting embodiment of the invention, the alkyl groups of the alkyl and alkoxy substituents are lower alkyl C1 to C4 straight or branched.

In another preferred, non-limiting embodiment, R², R³ and R⁴ are ethoxylate chains, where the number of ethoxylate moieties in each chain independently ranges from 1 to 16, preferably from 2 to 12.

It will be appreciated that formula (I) encompasses betaines and sultaines. In general, quaternary compounds can be converted to products with drag reducing properties by exchanging the halide for other ions such as salicylate, thiosalicylate, sulfonates, hydroxynaphthenate, etc. In one non-limiting embodiment. Similar compounds such as betaines and sultaines may be used as such or in combination with other surfactants. Cetyltrimethylammonium salicylate (CTAS) and Cetylpyridinium salicylate (CPS) are particularly preferred corrosion inhibitors.

It has been discovered that the salt forms of formula (I) are more effective as corrosion inhibitors than the corresponding amines alone. Without wishing to be bound to any particular theory, it may be that the counter ion permits the molecules of formula (I) to become associated together in such a way that imparts corrosion inhibition as well as drag reduction properties.

In the inventive corrosion inhibiting compositions, the proportion of corrosion inhibiting drag reducer in the composition ranges from about 1 to about 60 wt. %, preferably from about 5 to about 40 wt. %, and most preferably where the proportion of corrosion inhibitor in the composition ranges from about 10 to about 35 wt. %, in non-limiting embodiments. Solvents or diluents may be employed together with the composition of this invention, which may include, but are not necessarily limited to, water, alcohol, aromatic solvents, such as naphthas and xylene, and the like.

It will be appreciated that the inventive corrosion inhibiting composition of the invention can be used in any water-containing fluid contacting metal. By “fluid” is meant any fluid such as brine, emulsion of oil-in-water or water-in-oil or oil and water and gas mixtures; whether recovered from a hydrocarbon recovery operation; produced to assist with a hydrocarbon recovery operation, such as a hydrocarbon-containing drilling fluid or drill-in fluid (DIF); or produced as a by-product or waste product from a hydrocarbon refining or processing operation, or other process or the like. In the context of this invention, in emulsions of oil-in-water or water-in-oil, the “oil” need not be pure hydrocarbon, but may be any immiscible non-aqueous phase, typically an organic phase. While the invention is sometimes described herein in connection with oil and gas operations, and particularly with respect to production fluids, it will be appreciated that the invention is equally applicable to other processes including but not necessarily limited to heating and cooling systems, boiler operations, emulsion separations, etc.

It is difficult, if not impossible, to specify with precision the amount of composition of this invention that would be suitable to add to the fluid to impart corrosion inhibition properties thereto. Such an effective amount depends on a number of factors, including, but not necessarily limited to, the nature of the fluid, the nature of the corrosion inhibiting drag reducer, the properties of the fluid (e.g. temperature, pressure, pH, composition, contaminants, etc.), flow rates, and the like. However, in one non-limiting embodiment, the amount of composition added to a fluid to be effective may range from about 1 to about 1,000 ppm, based on the fluid, preferably from about 10 to about 200 ppm. The proportions of the effective additives herein are used as corrosion inhibitors in proportions approximately one tenth of the proportions employed when the additives are used as drag reducers.

The inventive composition is expected to find particular utility when the fluid to which it is added ranges in temperature from about 20° to about 60° C.

As mentioned, the inventive composition of this invention is also expected to reduce the power requirements for pumping the fluid to which the inventive composition has been added.

The invention will be further illustrated by the following examples that are merely intended to further demonstrate, but not limit, the invention.

### EXAMPLES 1-5

Example 1—Cetyltrimethylammonium salicylate (CTAS) was prepared from a 25% aqueous solution of cetyltrimethylammonium chloride and sodium salicylate in equimolar ratio. In addition, CTAS with a 0.42 molar excess of sodium salicylate was prepared.

Example 2—Cetyltrimethylammonium hydroxycoumarate was prepared by ring opening of dihydrocoumarin with a 50% aqueous solution of sodium hydroxide in a 1:1 molar ratio followed by reaction with cetyltrimethylammonium chloride in equimolar ratio.

Example 3—Cetyltrimethylammonium 2-coumarononate was prepared by ring opening of 2-coumaranone with a 25% aqueous solution of sodium hydroxide in a 1:1 molar ratio followed by reaction with cetyltrimethylammonium chloride in equimolar ratio.

Example 4—Cetyltrimethylammonium o-hydroxycinnamate was prepared by first ring opening of coumarin with a 50% aqueous solution of sodium hydroxide in a 1:1 molar ratio followed by reaction with cetyltrimethylammonium chloride in equimolar ratio.

Example 5—Cetylpyridinium salicylate (CPS) was prepared from cetylpyridinium chloride monohydrate and sodium salicylate as a 25% active solution in water/isopropanol (1/1 weight) in equimolar ratio.

Drag Reduction Measurements

A simple screening method, referred to as a vortex test, has been disclosed in U.S. Pat. No. 5,902,784, incorporated by reference herein, and was used to evaluate the products as drag reducers.

Vortex testing was carried out in a cylindrical glass vial with a diameter of 30 mm and a length of 120 mm. The vial was filled with 40-45 cc of liquid and placed in a water bath. A cylindrical glass stirring bar was used. The water bath was placed on a stirring plate that could be heated to a controlled temperature. Stirring at such a rate that a vortex of about 40-50 mm in depth was created.

A typical test constitutes filling the test vial with 40-45 cc of DI water, or brine, and placing the vial with stirring bar in the temperature bath. Stirring is started to create a 40-45 mm vortex and the vial is allowed to thermally equilibrate in the water bath. The chemical is added in increments using a micro-syringe until the vortex shows a substantial reduction. The reduction is recorded and the temperature of the bath slowly increased while recording the change in the depth of the vortex.

Chemicals that pass the vortex test, as indicated by a percent decrease in vortex height, were further tested in a torque measurement device. In this experiment, a cylinder spins at a constant rate in a cylindrical container, which contains the fluid. The cylinder is attached to a torque meter, which sends an analog voltage through a frequency filter. After the signal goes through the frequency filter, the signal is converted to a digital signal by an analog to digital converter. The digital signal then goes into a computer and is logged by a programming interface. Percent drag reduction for a particular DRA/solvent is calculated using the formula:

$$DR \% = \frac{( {Torque}_{Sol} - {Torque}_{DRA} )}{( {Torque}_{Sol} - {Torque}_{Air} )}$$

where Torque_{Air}, Torque_{Sol}, and Torque_{DRA} are torque values in air, solution without DRA, and solution with DRA, respectively.

Surface Tension Measurements

Surface tension measurements were made using instrumentation developed by SensaDyne® (a SensaDyne PC500-L Surface Tensiometer) that relies on the Maximum Bubble Pressure Method.

Corrosion Inhibitor Testing

Corrosion testing was performed using the kettle test method. A preliminary test at 500 rpm stir speed created a 60-80% vortex in tap water when measured from the bottom of the 1 liter kettle. The amount of CTAS and CPS inhibitor needed to create at least a 50% reduction in vortex was determined. The corresponding halides cetyltrimethylammonium chloride (CTACl) and cetylpyridinium chloride (CPCl) did not show any reduction in vortex. Sweet corrosion testing was then carried out at the concentration where a reduction in the vortex in the test kettle was observed. Tap water at ambient temperature was used with a 1-hour pre-corrode and a stir rate of 500 rpm. Weight loss, iron counts, and linear polarization readings were used to monitor the corrosion rates.

### EXAMPLE 6—Vortex Test of CTAS

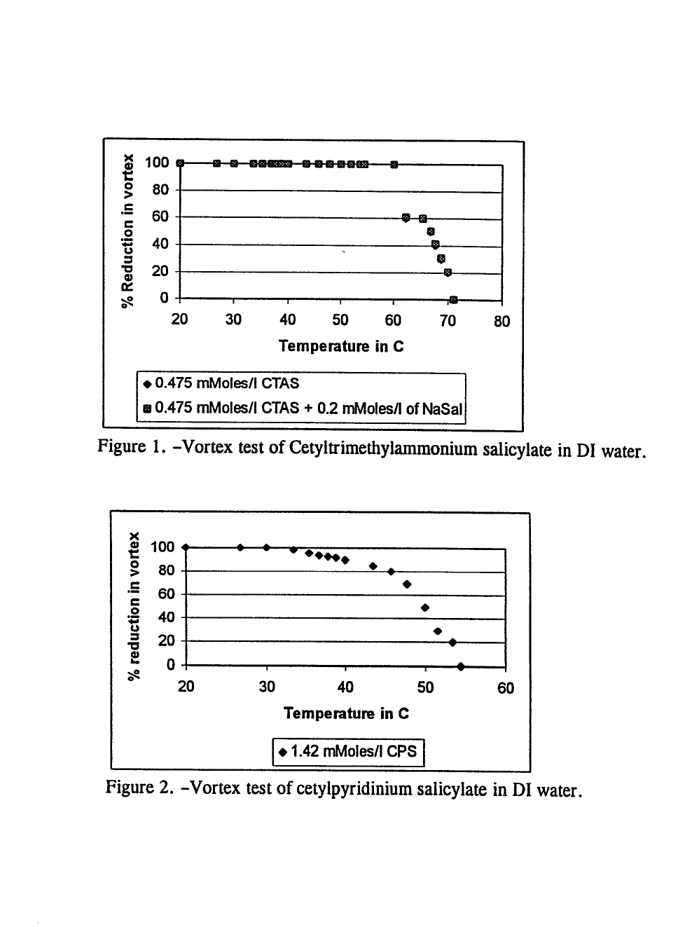

Cetyltrimethylammonium chloride (CTACl) was tested in the vortex test with (CTAS) and without (CTACl) added sodium salicylate as a function of temperature at 0.475 mMoles/l, to give the results shown in FIG. 1. This concentration of CTAS is required to completely reduce the vortex. Addition of sodium salicylate in excess of the stoichiometric amount to form CTAS had no effect on vortex reduction.

### EXAMPLE 7—Vortex Test of CPS

Cetylpyridinium salicylate of Example 5 was shown in the vortex test to require 1.42 mMoles/l at ambient temperature, compared with 0.475 mMoles/l for CTAS, to completely reduce the vortex in the test cell. The temperature profile at this concentration is shown in FIG. 2.

The following products were tested in the vortex test at 10 mMoles/liter, and no drag reduction was observed:

Cetyltrimethylammonium chloride.

Cetylpyridinium chloride.

Cethyltrimethylammonium hydroxycoumarate of Example 2.

Cethyltrimethylammonium 2-coumarononate of Example 3.

Cethyltrimethylammonium o-hydroxycinnamate of Example 4.

### EXAMPLE 8—Torque Measurements

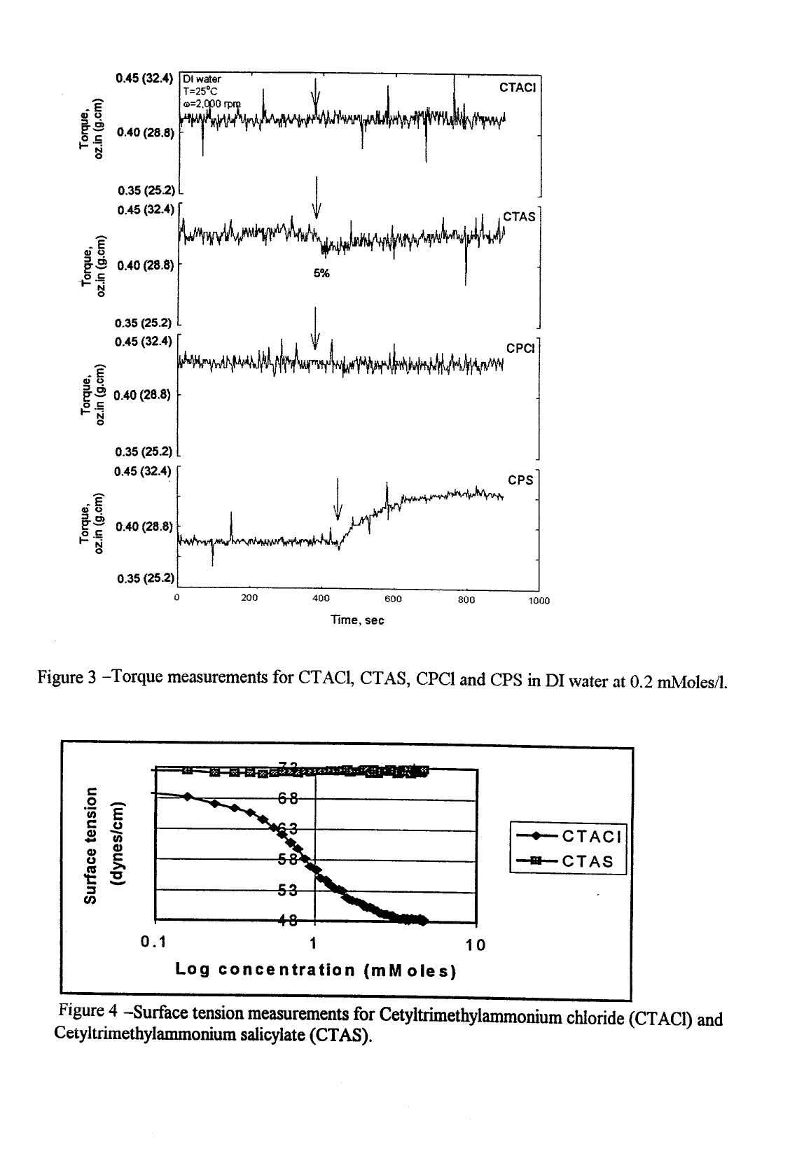

FIG. 3 shows the drag reduction results for CTACl, CTAS, CPCl, and CPS in DI water at room temperature at 0.2 mM/l. In this test, only CTAS exhibited drag reduction properties (5%), while CPS showed some increase in torque due to foam formation. Chloride salts of cetyltrimethylammonium and cetylpyridinium compounds showed no drag reduction effect. It should be noted that 5% drag reduction in the torque test is quite significant; maximum drag reduction of a conventional polymeric DRA is about 20% under these conditions.

### EXAMPLES 9 and 10—Dynamic Surface Tension Measurements

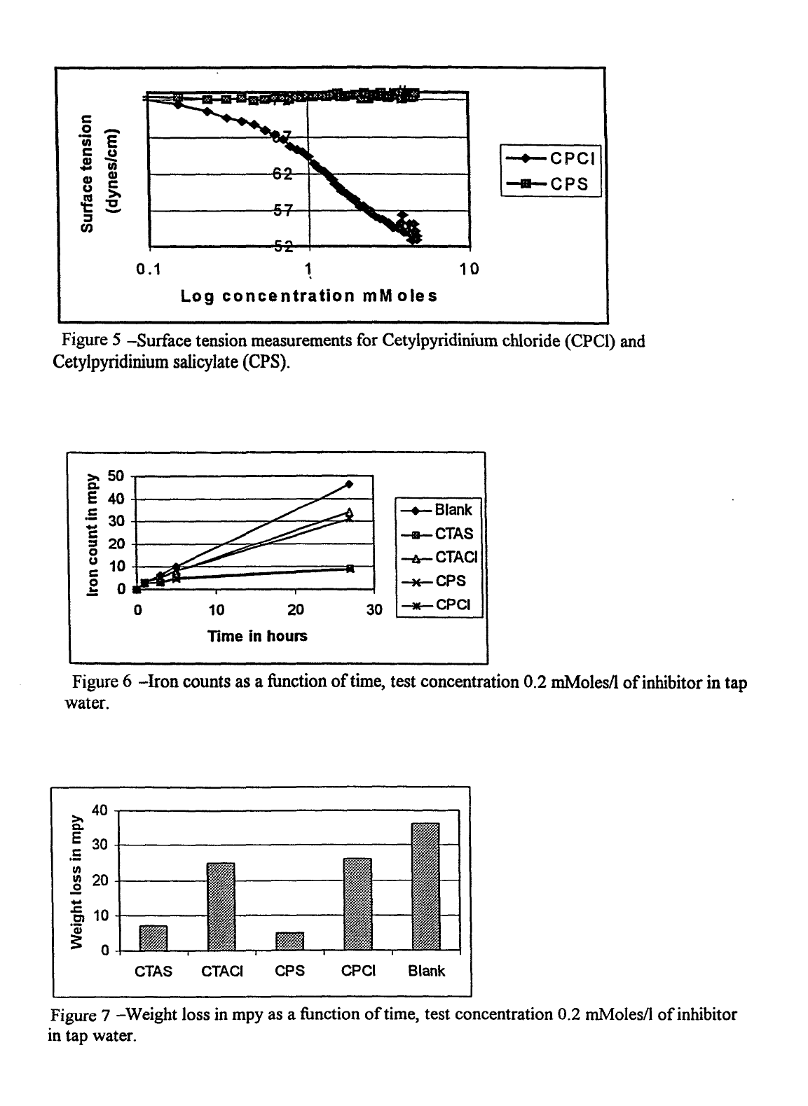

Dynamic surface tension was measured for cetyltrimethylammonium chloride and cetyltrimethylammonium salicylate. The results are shown in FIG. 4 (Example 9). Very similar results were obtained with the dynamic surface tension measurements of cetylpyridinium chloride (CPCl) and cetylpyridinium salicylate (CPS) as shown in FIG. 5 (Example 10). While both CTACl and CPCl showed strong surface tension suppression, no change in surface tension was obtained with CTAS and CPS. Some foaming was observed with the latter at higher concentrations resulting in slight increase in surface tension.

### EXAMPLE 11—Corrosion Inhibitor Testing

The kettle corrosion test was run under the following conditions:

| | |
|---|---|
| Fluids: | 900 ml tap water |
| Gas: | CO₂ sparge rate 0.4 scf/hr (0.01 m³/hr) |
| Temperature: | 70° F. (21° C.) |
| Agitation Rate: | 500 rpm = ω |

To a 1-liter kettle was added 900 ml of tap water. The fluid was stirred and sparged with CO₂ to remove O₂ for a minimum of 1 hour. Pre-weighed PAIR electrodes, degreased with xylene, IPA, hot water, and IPA were inserted into the kettle. After an initial uninhibited precorroded period of 1 hour, the corrosion inhibitor was injected. At certain time intervals, samples were withdrawn to determine the amount of Fe⁺⁺ present. After 27 hours the electrodes were removed, degreased with xylene, IPA, hot water, cleaned for 30 seconds in 10% inhibited HCl, rinsed with hot water, IPA and weighed.

The corrosion test results based on measured iron counts and converted to corrosion rates in mpy were plotted in FIG. 6 for CPCl, CPS, CTACl, and CTAS. Sodium salicylate tested at 0.5 mMoles/l under identical conditions showed a slightly higher corrosion rate than the blank. The results for weight loss measurements, an average of three coupons per test, expressed in mpy were plotted in FIG. 7.

The performance of cetyltrimethylammonium salicylate (CTAS) as a drag reducing agent (DRA) was reported by Smith, et al. in Structure and Flow in Surfactant Solutions, Chapter 26, American Chemical Society, 1994, pages 370-379. Drag reduction of CTAS at 5 mMoles with 7.5 mMoles excess of sodium salicylate in DI water was found between 10°-70° C. in a recirculating system using a 58-cm long, 0.616 cm diameter stainless steel section. The vortex test used in this work with CTAS showed drag reduction at 0.475 mMoles/l between 20°-60° C. (FIG. 1). Additional sodium salicylate did not change the results in the vortex test. In the torque test, drag reduction was observed at 0.2 mMol/l at 25° C. The flow pattern and/or flow regime are different in the two methods, drag reduction of different magnitude and at different concentrations may be expected.

Cetylpyridinium salicylate, CPS, showed drag reduction at 1.42 mMoles/l between 20°-55° C. in the vortex test (FIG. 2) and no drag reduction in the torque test. CPS also showed significant foaming under the torque test conditions (ω=2,000 rpm).

Surface tension measurements of CTAS and CPS showed an unexpected suppression of surface tension reduction of the quaternary parent compounds and the absence of their critical micelle concentrations (CMC). Critical micelle concentrations (CMC) for cetyltrimethylammonium chloride (CTACl) and cetylpyridinium chloride (CPCl) in water are about 1 and 1.2 mMoles/l, respectively (FIGS. 4 and 5). This can be explained by the formation of large agglomerates (micelles) that diffuse slowly to the bubble surface at the high bubble rates. These results agree with the observed slow mixing of the polymer-like strands of the quaternary salicylate compounds.

As shown, the counterion employed played a significant role in the drag reduction of the quaternary compounds. None of hydroxycoumarate, 2-coumarononate, and o-hydroxycinnamate ions showed any activity when combined with cetyldimethylammonium cation.

Corrosion testing was performed in water under conditions of low turbulence (Re>10,000) low shear rate. CTACl and CPCl were tested at 0.2 mMoles/l, which is below their CMC values, and showed little or no inhibition (FIGS. 6 and 7). This is not surprising since quaternary compounds are adequate inhibitors if tested in systems where they can form micelles. The CMC is usually much lower in brines or brine/hydrocarbon systems for these surfactants.

The corrosion test with CTAS and CPS in a configuration where drag reduction was evidenced in the vortex upon addition of the DRAs at 0.2 mMoles/l showed a significant reduction in the corrosion rate.

Even though there seems to be a correlation between drag reduction and corrosion inhibition, the exact mechanism of corrosion inhibition by the inventive DRAs tested cannot be resolved without further experimentation. The results suggest that they do not function as inhibitors by surface tension reduction as their chloride counterparts do. The conditions of corrosion testing were chosen to promote drag reduction and are not identical to actual field conditions. However, it is encouraging that a simple exchange of the counterion of the quaternary ammonium compounds affords products showing greater activity as a corrosion inhibitor. The initial goal to demonstrate that a molecule can have drag reduction and corrosion inhibiting properties simultaneously was achieved.

In the foregoing specification, the invention has been described with reference to specific embodiments thereof, and has been demonstrated as effective in improving corrosion inhibition while simultaneously achieving drag reduction. However, it will be evident that various modifications and changes can be made thereto without departing from the broader spirit or scope of the invention as set forth in the appended claims. Accordingly, the specification is to be regarded in an illustrative rather than a restrictive sense. For example, specific molecules other than those specifically tried, falling within the claimed parameters, but not specifically identified or tried in a particular application to inhibit corrosion and/or to reduce drag, are within the scope of this invention. Further, combinations of particular corrosion inhibiting compositions with aqueous fluids other than those exemplified herein are also within the scope of the invention.

We claim:

1. A corrosion inhibited fluid comprising:
a fluid comprising water; and
an amount effective to inhibit corrosion of a composition comprising the formula: 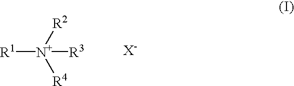
where R¹ is a straight or branched saturated alkyl having at least 12 carbon atoms;
R², R³ and R⁴ are independently lower alkyl of 1 to 4 carbon atoms, aryl, alkylaryl, or alkoxide where the alkoxide units constitute from 1 to 16 alkoxy moieties where the alkoxy moieties are independently from 2 to 4 carbon atoms, or any two of R², R³ and R⁴ are joined together to form cycloalkyl of 5 to 6 carbon atoms, or all three of R², R³ and R⁴ together with the N form a pyridinium ring, where R², R³ and R⁴ may be independently substituted with O or S; and
X⁻ is selected from the group of anions consisting of salicylate, thiosalicylate, sulfonate, and hydroxynaphthenate.

2. The corrosion inhibited fluid of claim 1 where R², R³ and R⁴ are independently lower alkyl of 1 to 4 carbon atoms, or all three of R², R³ and R⁴ together with the N form a pyridinium ring; and where X⁻ is salicylate.

3. The corrosion inhibited fluid of claim 1 where R², R³ and R⁴ are independently ethoxylate chains having from 1 to 16 ethoxy groups.

4. The corrosion inhibited fluid of claim 1 where the proportion of corrosion inhibiting composition ranges from about 1 to 1,000 ppm based on the corrosion inhibiting fluid.

5. A corrosion inhibited fluid comprising:
a fluid comprising water; and
from about 1 to 1,000 ppm based on the corrosion inhibiting fluid of a composition comprising the formula: 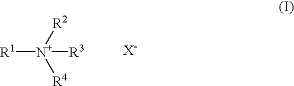
where R¹ is a straight or branched saturated alkyl having at least 12 carbon atoms;
R², R³ and R⁴ independently ethoxylate chains having from 1 to 16 ethoxy groups; and
X⁻ is selected from the group of anions consisting of salicylate, thiosalicylate, sulfonate, and hydroxynaphthenate.

6. A method for inhibiting corrosion of metal in contact with a fluid, where the method comprises;
providing the fluid, said fluid comprising water, in contact with metal;
adding a corrosion inhibiting effective amount of a composition having the formula: 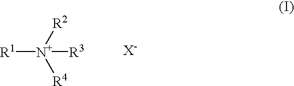
where R¹ is a straight or branched saturated alkyl having at least 12 carbon atoms;
R², R³ and R⁴ are independently lower alkyl of 1 to 4 carbon atoms, aryl, alkylaryl, or alkoxide where the alkoxide units constitute from 1 to 16 alkoxy moieties where the alkoxy moieties are independently from 2 to 4 carbon atoms, or any two of R², R³ and R⁴ are joined together to form cycloalkyl of 5 to 6 carbon atoms, or all three of R², R³ and R⁴ together with the N form a pyridinium ring, where R², R³ and R⁴ may be independently substituted with O or S; and
X⁻ is selected from the group of anions consisting of salicylate, thiosalicylate, sulfonate, and hydroxynaphthenate.

7. The method of claim 6 where in adding the composition, R², R³ and R⁴ are independently lower alkyl of 1 to 4 carbon atoms, or all three of R², R³ and R⁴ together with the N form a pyridinium ring; and where X⁻ is salicylate.

8. The method of claim 6 where R², R³ and R⁴ are independently ethoxylate chains having from 1 to 16 ethoxy groups.

9. The method of claim 6 where in adding the corrosion inhibiting drag reducer, the drag reducer is added in an amount ranging from about 1 to about 1,000 ppm, based on the fluid.

10. The method of claim 6 where the fluid is selected from the group consisting of aqueous fluids, aqueous and organic emulsions, oil-in-water emulsions, water-in-oil emulsions, and mixtures of water, an organic phase and gas.

11. A method for inhibiting corrosion of metal in contact with a fluid, where the method comprises:
providing the fluid selected from the group consisting of aqueous fluids and aqueous and hydrocarbon emulsions in contact with metal;
adding from about 1 to about 1,000 ppm of a composition having the formula: 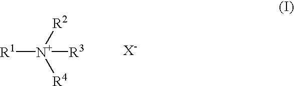
where R¹ is a straight or branched saturated alkyl having at least 12 carbon atoms;
R², R³ and R⁴ are independently ethoxylate chains having from 1 to 16 ethoxy groups; and
X⁻ is selected from the group of anions consisting of salicylate, thiosalicylate, sulfonate, and hydroxynaphthenate.

12. A method for reducing the power requirements of a pump that is pumping a fluid selected from the group consisting of aqueous fluids and aqueous and hydrocarbon emulsions, comprising:
providing a pump pumping the fluid;
adding upstream of the pump an effective amount of a composition to the fluid to reduce power requirements, where the composition comprises a drag reducer having the formula: 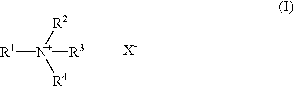
where R¹ is a straight or branched saturated alkyl having at least 12 carbon atoms;
R², R³ and R⁴ are independently lower alkyl of 1 to 4 carbon atoms, aryl, alkylaryl, or alkoxide where the alkoxide units constitute from 1 to 16 alkoxy moieties where the alkoxy moieties are independently from 2 to 4 carbon atoms, or any two of R², R³ and R⁴ are joined together to form cycloalkyl of 5 to 6 carbon atoms, or all three of R², R³ and R⁴ together with the N form a pyridinium ring, where R², R³ and R⁴ may be independently substituted with O or S; and
X⁻ is selected from the group of anions consisting of salicylate, thiosalicylate, sulfonate, and hydroxynaphthenate.

13. The method of claim 12 where in the composition R², R³ and R⁴ are independently lower alkyl of 1 to 4 carbon atoms, or all three of R², R³ and R⁴ together with the N form a pyridinium ring; and where X⁻ is salicylate.

14. The method of claim 12 where in the composition R², R³ and R⁴ are independently ethoxylate chains having from 1 to 16 ethoxy groups.

15. The method of claim 12 where the proportion of the composition ranges from about 1 to 1,000 based on the corrosion inhibiting fluid.
